(19) United States
(12) Patent Application Publication
(10) Pub. No.: US 2024/0383310 A1
(43) Pub. Date: Nov. 21, 2024

(54) APPARATUS FOR CONTROLLING BATTERY SYSTEM OF VEHICLE AND METHOD THEREOF

(71) Applicants: Hyundai Motor Company, Seoul (KR); Kia Corporation, Seoul (KR)

(72) Inventors: Mun Soon Kwon, Yongin (KR); Jae Woong Kim, Hwaseong (KR); Dong Kyu Lee, Uiwang (KR)

(21) Appl. No.: 18/389,178

(22) Filed: Nov. 13, 2023

(30) Foreign Application Priority Data
May 15, 2023 (KR) 10-2023-0062642

(51) Int. Cl. B60H 1/00

(52) U.S. Cl. CPC B60H 1/00735; B60L 1/003; B60L 15/2045

(57) ABSTRACT

An apparatus for controlling a battery system includes a high voltage battery mounted on a vehicle, high voltage loads electrically connected to the high-voltage battery, and a processor. The processor determines a peak at which an instantaneous output of the high voltage battery exceeds a preset reference range, determines a target load among the high voltage loads electrically connected to the high voltage battery, and enters a peak reduction control period for reducing the peak to control power consumption of the target load.

### CROSS-REFERENCE TO RELATED APPLICATION

This application claims under 35 U.S.C. § 119 (a) the benefit of Korean Patent Application No. 10-2023-0062642, filed in the Korean Intellectual Property Office on May 15, 2023, the entire contents of which are incorporated herein by reference.

### BACKGROUND

### (a) Technical Field

The present disclosure relates to an apparatus for controlling a battery system of a vehicle and a method thereof, more particularly, to a technique for improving the peak of a high voltage battery.

### (b) Description of the Related Art

An electric vehicle, which is an eco-friendly vehicle that obtains power by driving an electric motor using a high voltage battery, may be considered to fall into a category such as a hybrid electric vehicle (HEV), an electric vehicle (EV), a plug-in hybrid electric vehicle (PHEV), a fuel cell electric vehicle (FCEV), and the like.

An electric vehicle typically includes a high voltage battery, and the high voltage battery may supply power to a driving motor for driving wheels of a vehicle and a plurality of high voltage loads. The high voltage load may include a heater, an electric compressor, and the like.

A driving motor of the electric vehicle may exhibit a rapid change in required power due to rapid acceleration and deceleration of the electric vehicle or a rapid change in required power of an air conditioning system due to rapid cooling and heating, and as a result, a peak phenomenon may occur in which an output of the high voltage battery changes rapidly for a moment or a short period of time. The peak phenomenon of the high voltage battery output may damage parts of high-voltage loads electrically connected to the high voltage battery.

Therefore, there is a need to provide a method for improving a peak phenomenon of an output of a high voltage battery.

### SUMMARY

An aspect of the present disclosure provides an apparatus for controlling a battery system capable of improving a peak phenomenon of a high voltage battery mounted in an electric vehicle, and a method thereof.

In addition, another aspect of the present disclosure provides an apparatus for controlling a battery system capable of ensuring user convenience while improving a peak phenomenon of a high voltage battery.

The technical problems to be solved by the present disclosure are not limited to the aforementioned problems, and any other technical problems not mentioned herein will be clearly understood from the following description by those skilled in the art to which the present disclosure pertains.

In one aspect, an apparatus for controlling a battery system of a vehicle is provided, the apparatus comprising (a) a battery mounted on the vehicle; (b) loads electrically connected to the battery; and (c) a processor configured to: i) determine a peak at which an instantaneous output of the voltage battery exceeds a preset reference range, ii) determine a target load among the loads electrically connected to the high voltage battery, and iii) enter a peak reduction control period for reducing the peak to control power consumption of the target load.

In certain preferred aspects, the battery may be a high voltage battery and high voltage loads are electrically connected to the high voltage battery.

According to an aspect of the present disclosure, an apparatus for controlling a battery system of a vehicle includes a high voltage battery mounted on the vehicle, high voltage loads electrically connected to the high-voltage battery, and a processor. The processor determines a peak at which an instantaneous output of the high voltage battery exceeds a preset reference range, determines a target load among the high voltage loads electrically connected to the high voltage battery, and enters a peak reduction control period for reducing the peak to control power consumption of the target load.

According to an embodiment, the processor may determine that the instantaneous output enters the peak when an instantaneous output change of the high voltage battery is greater than or equal to a threshold value during a preset unit time from a reference time point at which the instantaneous output of the high voltage battery exceeds a preset first reference output.

According to an embodiment, the processor may control the power consumption of the target load by driving the target load to consume less power than power consumed by a user input.

According to an embodiment, the processor may drive the target load to consume power greater than the power consumed by the user input after controlling the power consumption of the target load.

According to an embodiment, the processor may determine that the instantaneous output enters the peak when the instantaneous output change of the high voltage battery is greater than or equal to a threshold value during a preset unit time from a reference time point at which the instantaneous output of the high voltage battery is less than a preset second reference output.

According to an embodiment, the processor may control the power consumption of the target load by driving the target load to consume greater power than power consumed by a user input.

According to an embodiment, the processor may drive the target load to consume power less than the power consumed by the user input after controlling the power consumption of the target load.

According to an embodiment, the processor may determine a load having highest power consumption during a preset unit time from the reference time point among the high voltage loads as the target load.

According to an embodiment, the processor may accumulate timing at which a peak control period for controlling power consumption of the target load proceeds, and drive the target load based on a user input when the accumulated peak control period is greater than or equal to a preset threshold period.

According to an embodiment, the processor may determine an air conditioning system of the vehicle as the target load, and drive the target load based on a user input when a change in an indoor temperature of the vehicle according to control of power consumption of the air conditioning system is equal to or greater than a preset threshold temperature.

According to another aspect of the present disclosure, a method of controlling a battery system of a vehicle includes mounting a high voltage battery on the vehicle, electrically connecting high voltage loads to the high voltage battery, monitoring an instantaneous output of a high voltage battery and detecting a peak in which the instantaneous output of the high voltage battery exceeds a preset reference range, determining a target load among high voltage loads electrically connected to the high voltage battery when the peak is detected, and entering a peak reduction control period for reducing the peak and controlling power consumption of the target load.

According to an embodiment, the determining of the peak may include detecting a reference time point at which the instantaneous output of the high voltage battery exceeds a preset first reference output, and determining that the instantaneous output enters the peak when an instantaneous output change of the high voltage battery is greater than or equal to a threshold value during a preset unit time from the reference time point.

According to an embodiment, the controlling of the power consumption of the target load may include driving the target load to consume less power than power consumed by a user input.

According to an embodiment, the method may further include compensating for a change in an output of the target load by driving the target load to consume power greater than the power consumed by the user input after controlling the power consumption of the target load.

According to an embodiment, the determining of the peak may include detecting a reference time point at which the instantaneous output of the high voltage battery is less than a preset second reference output, and determining that the instantaneous output enters the peak when an instantaneous output change of the high voltage battery is greater than or equal to a threshold value during a preset unit time from the reference time point.

According to an embodiment, the controlling of the power consumption of the target load may include driving the target load to consume greater power than power consumed by a user input.

According to an embodiment, the method may further include compensating for a change in an output of the target load by driving the target load to consume power less than the power consumed by the user input after controlling the power consumption of the target load.

According to an embodiment, the determining of the target load may include determining a load having highest power consumption during a preset unit time from a reference time point among the high voltage loads as the target load.

According to an embodiment, the controlling of the power consumption of the target load may include accumulating timing at which the peak reduction control period for controlling power consumption of the target load proceeds, and driving the target load based on a user input when the accumulated peak reduction control period is greater than or equal to a preset threshold period.

According to an embodiment, the controlling of the power consumption of the target load may include controlling power consumption of an air conditioning system of a vehicle to allow the air conditioning system of the vehicle to be driven with power consumption greater than or less than power consumption by a user input, detecting a change in indoor temperature of the vehicle according to the controlling of the power consumption of the air conditioning system, and driving the target load based on the user input when the change in indoor temperature is equal to or greater than a preset threshold temperature.

A battery of an apparatus or vehicle as discussed herein suitably may be a high voltage battery. In certain embodiments, a battery may be charged to store power, or discharged to supply power. For a high-performance fuel cell vehicle, the high voltage battery having a large capacity may be used. Further, a plug-in hybrid vehicle (PHEV) which is supplied with power externally from a vehicle to be charged may include an onboard charger (OBC). Alternatively, the high voltage battery may be supplied with power supplied externally from the vehicle by an external charger to be charged, or may be charged in the vehicle with the power of the fuel cell or the like without being plugged into the external power source.

In one aspect, the battery has a relatively high voltage output (e.g., at least nominal 200, 250 or 300 V).

In further aspects, vehicles are provided that comprises a battery or battery apparatus as disclosed herein.

### BRIEF DESCRIPTION OF THE DRAWINGS

The above and other objects, features and advantages of the present disclosure will be more apparent from the following detailed description taken in conjunction with the accompanying drawings:

FIG. 1 is a diagram illustrating an apparatus for controlling a battery system according to an embodiment of the present disclosure;

FIG. 2 is a flowchart illustrating a method of controlling a battery system according to an embodiment of the present disclosure;

FIG. 3 is a schematic diagram illustrating an example of controlling power consumption of a target load corresponding to an overpower peak;

FIG. 4 is a schematic diagram illustrating an embodiment of controlling power consumption of a target load in response to a low power peak;

FIG. 5 is a diagram illustrating an instantaneous output change of a high voltage battery during driving of a vehicle;

FIG. 6 is a diagram illustrating an example of a peak detection method;

FIG. 7 is a diagram illustrating an example of controlling a driving signal of a target load corresponding to a high power peak;

FIG. 8 is a diagram illustrating an example of controlling a driving signal of a target load corresponding to a low power peak;

FIG. 9 is a diagram illustrating an apparatus for controlling a battery system according to another embodiment of the present disclosure;

FIG. 10 is a circuit diagram illustrating a connection relationship between load controllers, a BMS, and an inverter;

FIG. 11 is a flowchart illustrating a method of controlling a battery system according to another embodiment of the present disclosure; and

FIG. 12 is a block diagram illustrating a computing system according to an embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

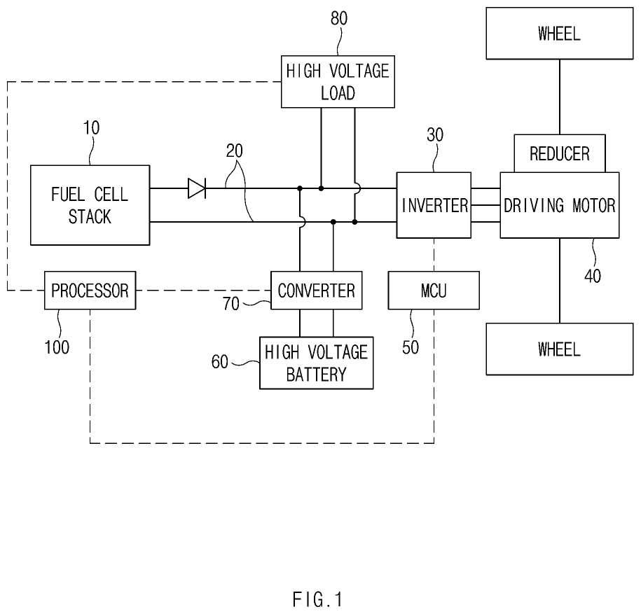

Hereinafter, with reference to FIGS. 1 to 12, embodiments of the present disclosure will be described in detail.

FIG. 1 is a diagram illustrating an apparatus for controlling a battery system according to an embodiment of the present disclosure.

Referring to FIG. 1, an apparatus for controlling a battery system according to an embodiment of the present disclosure may include a fuel cell 10, an inverter 30, a driving motor 40, a motor control unit (MCU) 50, a converter 70, a high voltage battery 60, a high voltage load 80, and a processor 100.

In the fuel cell 10, fuel gas and oxygen react electrochemically to convert chemical energy into electrical energy. The fuel cell 10 may be configured in a stacked structure in which a plurality of cells are stacked, where each cell may receive hydrogen gas included in fuel gas and air and induce oxidation and reduction reactions to generate electrical energy. Each cell of the fuel cell may be protected from the outside by an end plate, and include an electrode-electrolyte assembly (Membrane & Electrode Assembly (MEA)) that oxidizes/reduces hydrogen gas and air and at least one or more separators that supply fuel gas and air to the MEA.

The fuel cell 10 is connected to the inverter 30 that supplies power to the driving motor 40 through a main bus terminal 20.

The inverter 30, which converts an input voltage into a three-phase voltage and provides it to the driving motor 40, may include a U-phase voltage generator, a V-phase voltage generator, and a W-phase voltage generator. An output terminal of each voltage generator may be connected to a 3-phase voltage input terminal of the motor.

The driving motor 40 may receive power from the fuel cell 10 or the high voltage battery 60 to drive the vehicle.

The MCU 50 may be a controller that controls the inverter 30 for supplying power to the driving motor 40 to control the RPM or torque of the driving motor 40.

The high voltage battery 60 is connected to the main bus terminal 20 through the converter 70. The high voltage battery 60 may receive power from the main bus terminal 20 or supply power to the main bus terminal 20.

The converter 70, which is to boost the voltage of the high voltage battery 60 to a voltage required by the driving motor 40, may be a high-voltage DC/DC converter (HDC), and a high voltage DC/DC converter (BHDC) capable of supplying power in both directions.

The high voltage load 80 may be an electric component electrically connected to the high voltage battery 60. For example, the high voltage load 80 may include a low voltage DC-DC converter (LDC), an on board charger (OBC), a positive temperature coefficient (PTC) heater, and an electric compressor. The LDC may reduce the voltage of the high voltage battery 60 and provide power to components driven using a low voltage. The OBC may convert AC power outside the vehicle into DC power. The PTC heater, which is a component included in an air conditioning system of a vehicle, may perform a heating function. The electric compressor, which is a component included in the air conditioning system of a vehicle, may circulate a refrigerant of an air conditioner for cooling.

The processor 100 may perform a function of a high level controller for controlling overall operation of the vehicle, and may include a function of a lower level controller for controlling the high voltage load 80 and the like. The processor 100 may perform a function of a fuel cell control unit (FCU).

The processor 100 may determine a peak in which an instantaneous output of the high voltage battery 60 exceeds a preset reference range.

The reference range may be set using a first reference output and a second reference output set in advance. The first reference output may be set higher than the second reference output. When the instantaneous output of the high voltage battery 60 exceeds the first reference output, the processor 100 may determine that a high power peak has occurred, and when the instantaneous output of the high voltage battery 60 is less than or equal to the second reference output, the processor 100 may determine that a low power peak has occurred.

When a peak is detected, the processor 100 may determine a target load among high voltage loads 80 electrically connected to the high voltage battery 60. The processor 100 may determine, as a target load, a high voltage load having the greatest power consumption during a preset unit time. Alternatively, the processor 100 may determine, as target loads, high voltage loads related to the air conditioning system of the vehicle among the high voltage loads. For example, the processor 100 may determine a PTC heater or an electric compressor as a target load.

When a peak is detected, the processor 100 may adjust power consumption of a target load by entering a peak reduction control period for reducing the peak. The instantaneous output of the high voltage battery 60 may vary depending on the power consumption of the driving motor 40 and the high voltage loads 80 electrically connected to the high voltage battery 60, and it is possible to alleviate a sudden change in instantaneous output of the high voltage battery 60 by controlling the power consumption of the high voltage load 80. In the case of an overpower peak, the processor 100 may drive the target load such that the target load consumes less power. In the case of a low power peak, the processor 100 may drive the target load such that the target load consumes a lot of power.

In addition, the processor 100 may enter a compensation period for compensating for a change in output of the target load after the peak reduction control period ends. The compensation period may be a period for compensating for the adjustment of the output of the target load differently from a user input during the peak reduction control period. Accordingly, when the power consumption of the target load is controlled to decrease during the peak reduction control period corresponding to the overpower peak, the processor 100 may control the power consumption of the target load to increase during the compensation period. In addition, when the power consumption of the target load is increased corresponding to the low power peak during the peak reduction control period, the processor 100 may control the power consumption of the target load to decrease during the compensation period.

In addition, the processor 100 may include a memory to perform a specific procedure using one or more algorithms. The memory may include a hard disk drive, a flash memory, an electrically erasable programmable read-only memory (EEPROM), a static RAM (SRAM), a ferro-electric RAM (FRAM), a phase-change RAM (PRAM), a magnetic RAM (MRAM), a dynamic random access memory (DRAM), a synchronous dynamic random access memory (SDRAM), a double date rate-SDRAM (DDR-SDRAM), and the like.

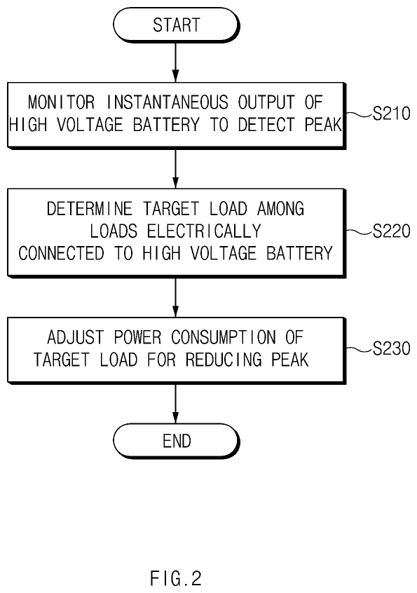

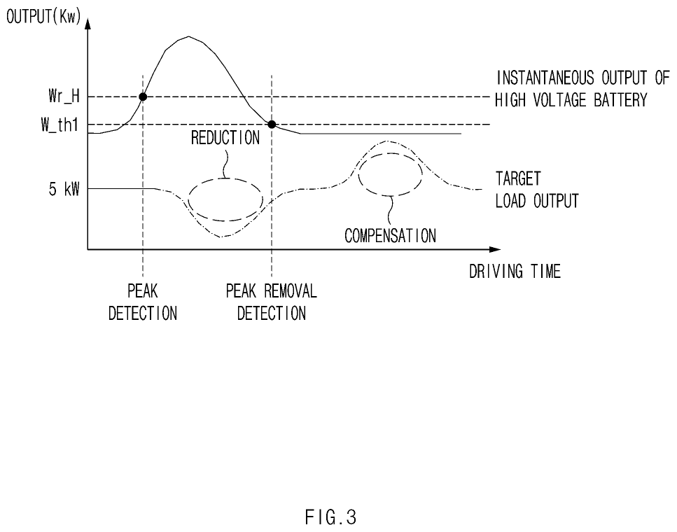

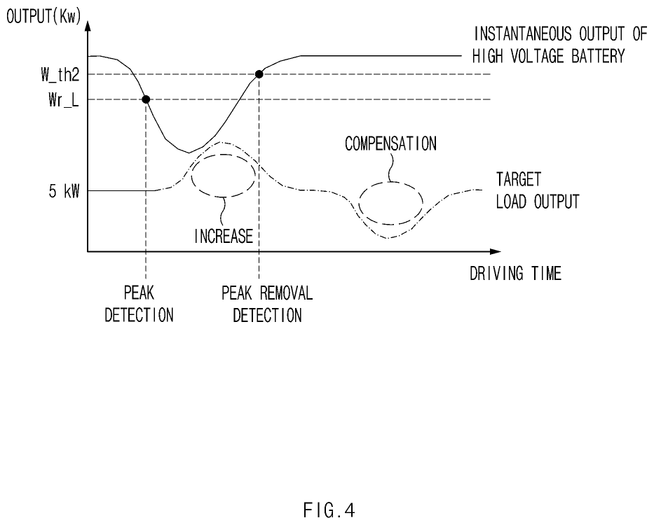

FIG. 2 is a flowchart illustrating a method of controlling a battery system according to an embodiment of the present disclosure. Each process shown in FIG. 2 may be controlled by the processor of FIG. 1. FIGS. 3 and 4 are diagrams illustrating an example of controlling power consumption of a target load according to an embodiment of the present disclosure. FIG. 3 is a schematic diagram illustrating an example of controlling power consumption of a target load corresponding to an overpower peak. FIG. 4 is a schematic diagram illustrating an embodiment of controlling power consumption of a target load in response to a low power peak.

Hereinafter, a method of controlling a battery system according to an embodiment of the present disclosure will be described with reference to FIGS. 2 to 4.

In S210, the processor 100 may monitor the instantaneous output of the high voltage battery 60 and detect a peak in which the instantaneous output of the high voltage battery 60 exceeds a preset reference range.

The reference range may be set to a range greater than or equal to a second reference output Wr_L and less than or equal to a first reference output Wr_H, and the first reference output Wr_H and the second reference output Wr_L may be set in advance.

As shown in FIG. 3, the processor 100 may determine that an overpower peak occurs when the instantaneous output of the high voltage battery 60 exceeds the first reference output Wr_H.

In addition, as shown in FIG. 4, the processor 100 may determine that a low power peak occurs when the instantaneous output of the high voltage battery 60 is less than the second reference output Wr_L.

In S220, the processor 100 may determine a target load among high voltage loads electrically connected to the high voltage battery 60.

The processor 100 may determine a high voltage load having the largest instantaneous power consumption as a target load at the time when the peak is detected.

Alternatively, the processor 100 may monitor the power consumption of the high voltage loads during a certain time period from a reference time point at which the peak is detected, and determine the high voltage load having the greatest power consumption during a certain time period as the target load.

In S230, the processor 100 may enter a peak reduction control period for reducing the peak and adjust the power consumption of the target load.

The peak reduction control period may be a period from a time point when a peak is detected to a time point when a peak reduction is detected.

As shown in FIG. 3, the processor 100 may determine that the peak is removed when the instantaneous output of the high voltage battery 60 is reduced from the overpower peak to a first threshold power W_th1 or less. The first threshold power W_th1 may be set to a level smaller than the first reference output Wr_H.

In addition, as shown in FIG. 4, the processor 100 may determine that the peak is removed when the instantaneous output of the high voltage battery 60 rises from the low power peak to second threshold power W_th2 or higher. The second threshold power W_th2 may be set to a level greater than the second reference output Wr_L.

As shown in FIG. 3, the processor 100 may drive the target load such that the target load output is reduced in the peak reduction control period corresponding to the overpower peak. For example, when the target load is in a state of using power consumption of 5 kw, the processor 100 may adjust the output of the target load such that the target load consumes power less than 5 kw.

As shown in FIG. 4, the processor 100 may drive the target load such that the target load output increases in the peak reduction control period corresponding to the low power peak. For example, when the target load is in a state of consuming power of 5 kw, the processor 100 may adjust the output of the target load such that the target load uses power greater than 5 kw.

After the peak reduction control period, the processor 100 may compensate the output of the target load.

When the output of the target load is adjusted by the peak reduction control, the load may be controlled differently from the setting of a user. For example, when the target load is an air conditioning system, the target load may not be able to maintain a temperature setting desired by the user due to peak reduction control. The processor 100 may compensate the output of the target load such that the target load is driven according to user settings.

As shown in FIG. 3, the processor 100 may control the target load such that the power consumption of the target load increases after the peak reduction control period corresponding to the high power peak ends.

Alternatively, as shown in FIG. 4, the processor 100 may control the target load such that power consumption of the target load decreases after the peak reduction control period corresponding to the low power peak ends.

In addition, the processor 100 may accumulate the timing at which the peak reduction control period proceeds. In proportion to the timing of the peak reduction control period, the target load may have a large deviation from driving by a user input. Accordingly, the processor 100 may drive a target load based on a user input without performing a peak reduction control operation when the accumulated peak reduction control period is greater than or equal to a preset threshold period.

In addition, the processor 100 may subtract the compensation control period in the process of accumulating the timing of the peak reduction control period. This is because the compensation control period may change the power consumption of the target load to be contrary to the peak reduction control.

In addition, when the target load is an air conditioning system, the processor 100 may monitor a change in indoor temperature of the vehicle according to a change in power consumption of the target load. When a change in indoor temperature due to a change in power consumption of the target load is equal to or greater than a preset threshold temperature, the processor 100 may drive the target load based on a user input without performing a peak reduction control operation.

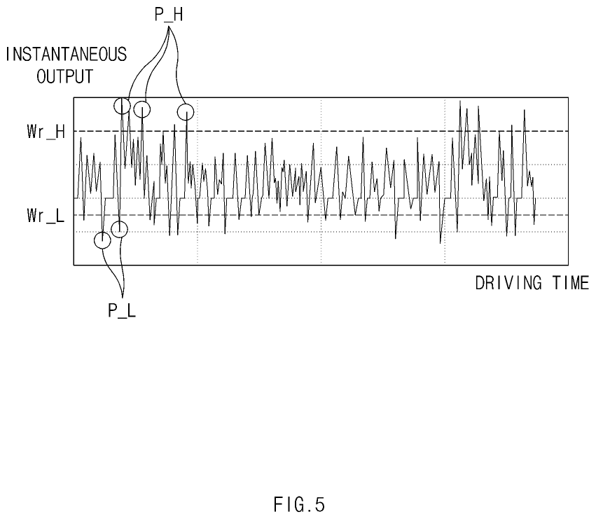

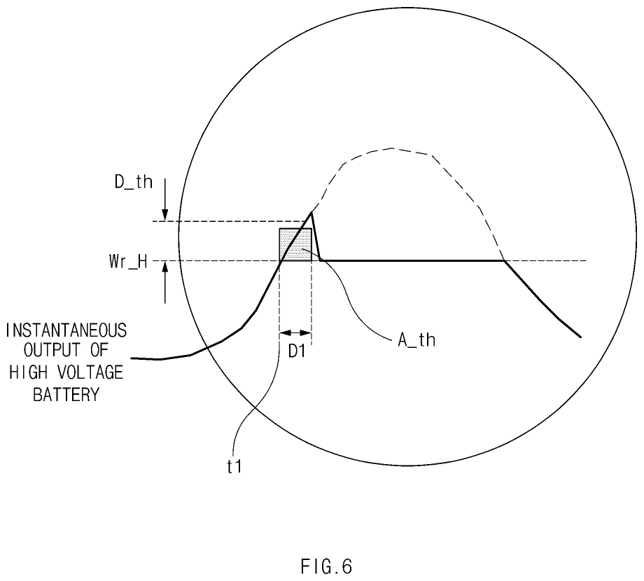

FIGS. 5 and 6 are diagrams illustrating a peak detection method according to an embodiment of the present disclosure. FIG. 5 is a diagram illustrating an instantaneous output change of a high voltage battery during driving of a vehicle. FIG. 6 is a diagram illustrating an example of a peak detection method. In particular, FIG. 6 illustrates a method of detecting a high power peak, and shows an example of a high power peak P_H shown in FIG. 5.

Hereinafter, a peak detection method will be described with reference to FIGS. 5 and 6.

Referring to FIG. 5, the processor 100 may monitor an instantaneous output change of the high voltage battery 60 as the vehicle travels.

With reference to FIG. 6, a method of detecting a peak using a threshold value D_th and a method of detecting a peak using a threshold region A_th will be described as follows.

As shown in FIG. 6, the processor 100 may determine a time point when the instantaneous output of the high voltage battery 60 exceeds the first reference output Wr_H as a reference time point t1.

The processor 100 may calculate an amount of change in the instantaneous output of the high voltage battery 60 during a unit time D1 from the reference time point t1. The processor 100 may detect that a peak occurs when the amount of change in the instantaneous output of the high voltage battery 60 is greater than or equal to the threshold value D_th. The threshold value, which is a reference value having a positive magnitude for comparing the amount of change in the instantaneous output of the high voltage battery 60, may be used even in the process of detecting a low output peak.

In addition, the processor 100 may calculate an integral value of the instantaneous output of the high voltage battery 60 during the unit time D1 from the reference time point t1. In addition, the processor 100 may determine that a peak occurs when the integral value of the instantaneous output of the high voltage battery 60 during the unit time D1 is equal to or greater than a half of the preset threshold region A_th. The threshold region A_th may be a preset rectangular area having one side of unit time D1.

As a determination result of the processor 100, as shown in FIG. 5, the high power peaks P_H and the low power peaks P_L may appear randomly and repeatedly, and corresponding to the detection of each of the high power peaks P_H and the low power peaks P_L, the processor 100 may perform peak reduction control.

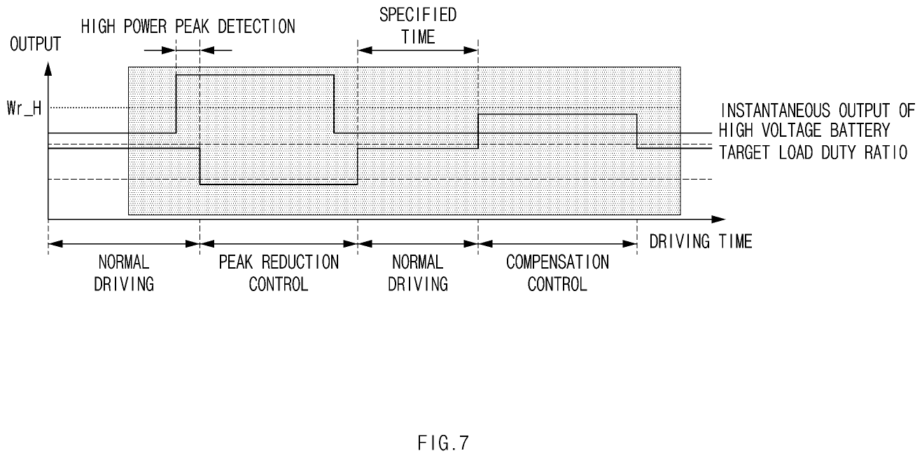

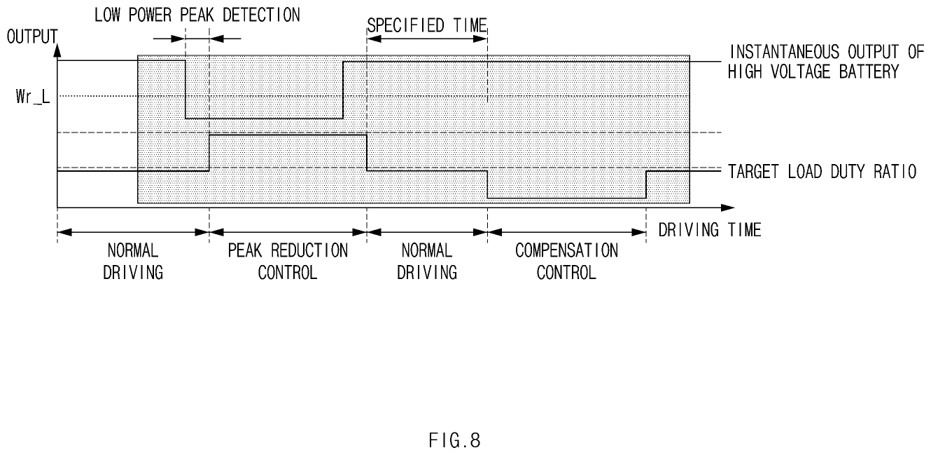

FIGS. 7 and 8 are diagrams illustrating an example of controlling a driving signal of a target load in order to control power consumption of the target load. FIG. 7 is a diagram illustrating an example of controlling a driving signal of a target load corresponding to a high power peak. FIG. 8 is a diagram illustrating an example of controlling a driving signal of a target load corresponding to a low power peak. The high power peak detection period shown in FIG. 7 and the low power peak detection period shown in FIG. 8 may be the unit time D1 shown in FIG. 6. In addition, normal driving in FIGS. 7 and 8 may mean a section in which a target load is controlled corresponding to a user input.

With reference to FIG. 7, an example of controlling a driving signal of a target load corresponding to a high power peak will be described below.

Referring to FIG. 7, the processor 100 may adjust the output of the target load after detecting a high power peak. To this end, the processor 100 may adjust a pulse width modulation (PWM) duty ratio of the target load. That is, the processor 100 may reduce the PWM duty ratio of the target load when detecting a high power peak. For example, when the target load is driven with a duty ratio of 50% in normal driving according to a user input, the processor 100 may set the duty ratio of the target load to 30%.

After the peak reduction control is finished, the processor 100 may perform normal driving for a specified time and then perform compensation control. The processor 100 may increase the duty ratio of the target load in the compensation control period corresponding to the high power peak. For example, the processor 100 may set the duty ratio of the target load to 70% in the compensation control period corresponding to the high power peak.

With reference to FIG. 8, an example of controlling a driving signal of a target load corresponding to a low power peak will be described below.

Referring to FIG. 8, the processor 100 may adjust the output of the target load after detecting a low power peak. To this end, the processor 100 may adjust the PWM duty ratio of the target load. That is, the processor 100 may increase the PWM duty ratio of the target load when detecting a low power peak. For example, when the target load is driven with a duty ratio of 50% in normal driving according to a user input, the processor 100 may set the duty ratio of the target load to 70%.

After the peak reduction control is finished, the processor 100 may perform normal driving for a specified time, and then perform compensation control. The processor 100 may decrease the duty ratio of the target load in the compensation control period corresponding to the low power peak. For example, the processor 100 may set the duty ratio of the target load to 30% in the compensation control period corresponding to the low power peak.

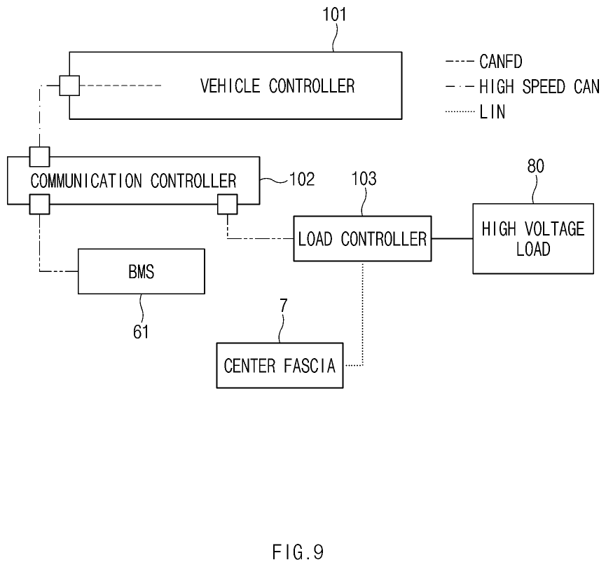

FIG. 9 is a diagram illustrating an apparatus for controlling a battery system according to another embodiment of the present disclosure.

Referring to FIG. 9, an apparatus for controlling a battery system according to another embodiment of the present disclosure may include the high voltage loads 80 and a plurality of controllers 101, 102 and 103 for controlling the high voltage loads 80. The plurality of controllers 101, 102 and 103 may perform several functions of the processor 100 shown in FIG. 1, respectively.

The vehicle controller 101 may be a high level controller that controls overall operation of the vehicle. The vehicle controller 101 may be connected to a load controller and a battery management system (BMS) through the communication controller 102. The vehicle controller 101 and the communication controller 102 may use high-speed CAN communication. A BMS 61 and the load controller 103 may be connected to the communication controller 102 through CAN FD communication. A center fascia 7 may be connected to the load controller 103 through LIN communication.

The BMS 61 may obtain battery information such as voltage, current, internal resistance, and state of charge (hereinafter, SOC) of the high voltage battery 60, and include a sensor for measuring each information.

The load controller 103 may control the operation of the high voltage load 80.

The center fascia 7 may be a user input device for controlling accessory devices of the vehicle, and may transmit a user input for driving the high voltage load 80 to the load controller 103.

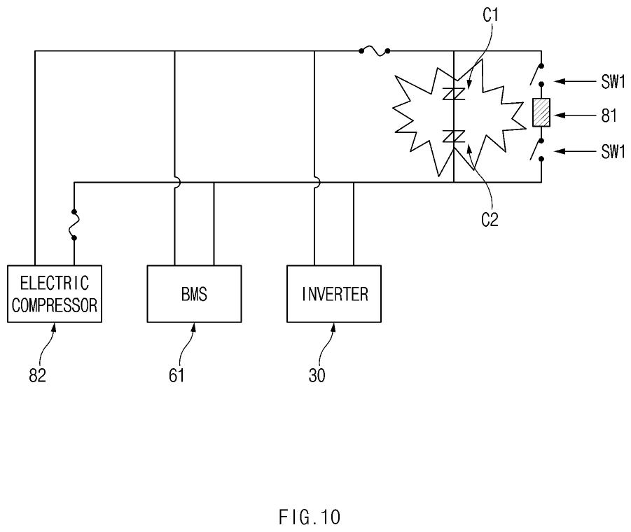

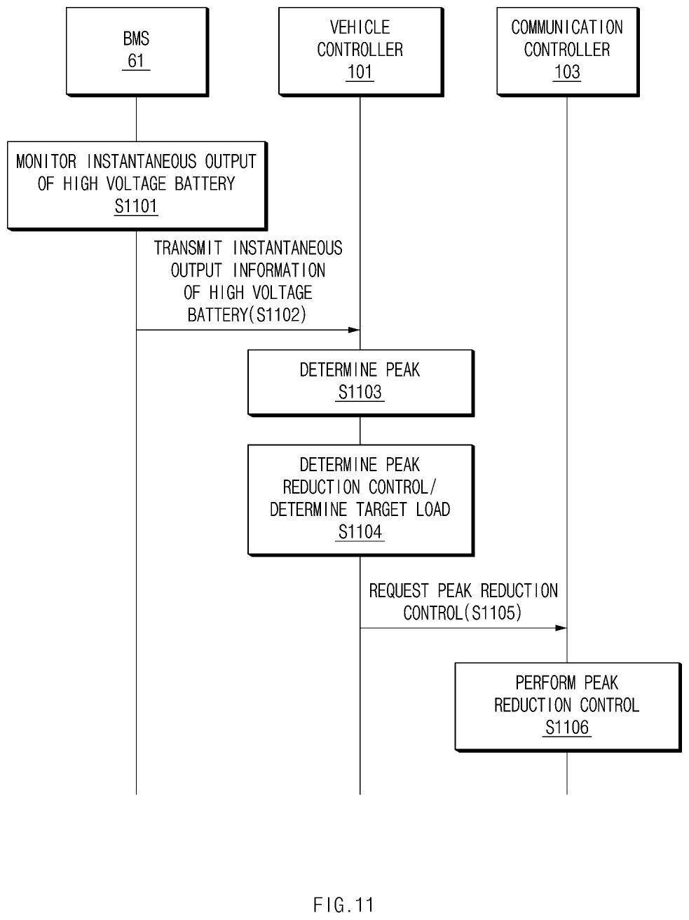

FIG. 10 is a circuit diagram illustrating a connection relationship between load controllers, a BMS, and an inverter. FIG. 11 is a flowchart illustrating a method of controlling a battery system according to another embodiment of the present disclosure.

Hereinafter, a method of controlling a battery system according to another embodiment of the present disclosure will be described with reference to FIGS. 10 and 11.

As shown in FIG. 10, the high voltage loads 80 of the battery system according to an embodiment of the present disclosure may include an electric compressor 82 and a PTC heater 81. Both ends of the PTC heater 81 may include a first switch SW1 and a second switch SW2 for operation control. The first and second switches SW1 and SW2 may be implemented with insulated gate bipolar transistors. In addition, both ends of the PTC heater 81 may include a first capacitor C1 and a second capacitor C2 for voltage stability of the circuit.

When the instantaneous output of the driving motor 40 changes rapidly, it may affect the control circuit of the PTC heater 81 electrically connected thereto, and as a result, the capacitors C1 and C2 connected to the PTC heater 81 may be damaged.

With reference to FIG. 11, a method of improving the peak phenomenon of the battery system shown in FIG. 10 will be described below.

In S1101, the BMS 61 may monitor an instantaneous output change of the high voltage battery 60. The BMS 61 may determine an instantaneous output change based on the amount of current change of the high voltage battery 60.

In S1102, the BMS 61 may transmit the output monitoring result of the high voltage battery 60 to the vehicle controller 101.

In S1103, the vehicle controller 101 may determine an output peak based on the output monitoring result of the high voltage battery 60 provided from the BMS 61. The vehicle controller 101 may determine that an output peak occurs when the instantaneous output of the high voltage battery 60 exceeds a preset reference range.

In S1104, when an output peak of the high voltage battery 60 occurs, the vehicle controller 101 may determine peak reduction control to reduce the peak. The peak reduction control may include a procedure for adjusting power consumption of a target load.

In S1105, the vehicle controller 101 may request the peak reduction control from the load controller 103. The peak reduction control may include the type of a target load and driving information for reducing power consumption of the target load.

In S1106, the load controller 103 may perform the peak reduction control of the target load based on the information provided from the vehicle controller 101. For example, when the instantaneous output of the high voltage battery 60 is an overpower peak, the load controller 103 may drive the target load to reduce power consumption of the target load. Alternatively, when the instantaneous output of the high voltage battery 60 is a low power peak, the load controller 103 may drive the target load to increase power consumption of the target load.

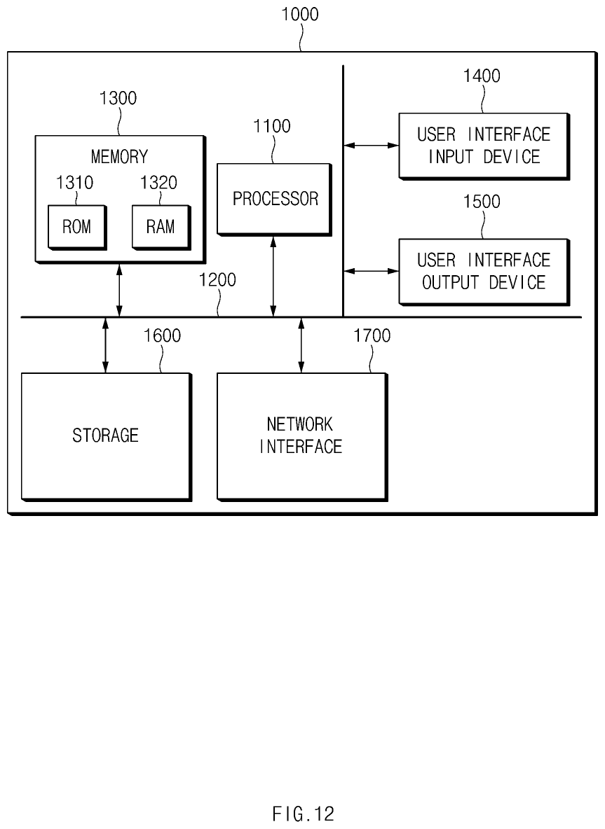

FIG. 12 is a block diagram illustrating a computing system according to an embodiment of the present disclosure.

Referring to FIG. 12, a computing system 1000 may include at least one processor 1100, a memory 1300, a user interface input device 1400, a user interface output device 1500, storage 1600, and a network interface 1700 connected through a bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) and a RAM (Random Access Memory).

Accordingly, the processes of the method or algorithm described in relation to the embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM.

The exemplary storage medium is coupled to the processor 1100, and the processor 1100 may read information from the storage medium and may write information in the storage medium. In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

According to the embodiments of the present disclosure, the peak of a high voltage battery may be improved by controlling the output of a high voltage load corresponding to the peak of the high voltage battery.

In addition, according to the embodiments of the present disclosure, by additionally performing compensation control corresponding to the peak reduction control, it is possible to drive a high voltage load while reflecting the user setting by compensating for a change in driving setting of the high voltage load due to the peak reduction control.

In addition, various effects that are directly or indirectly understood through the present disclosure may be provided.

Although exemplary embodiments of the present disclosure have been described for illustrative purposes, those skilled in the art will appreciate that various modifications, additions and substitutions are possible, without departing from the scope and spirit of the disclosure.

Therefore, the exemplary embodiments disclosed in the present disclosure are provided for the sake of descriptions, not limiting the technical concepts of the present disclosure, and it should be understood that such exemplary embodiments are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. An apparatus for controlling a battery system of a vehicle, the apparatus comprising:
a battery mounted on the vehicle;
loads electrically connected to the battery; and
a processor configured to:
determine a peak at which an instantaneous output of the battery exceeds a preset reference range,
determine a target load among the loads electrically connected to the battery, and
enter a peak reduction control period for reducing the peak to control power consumption of the target load.

2. The apparatus of claim 1 wherein the battery is a high voltage battery and loads connected to the battery are high voltage loads.

3. The apparatus of claim 1, wherein the processor is configured to determine that the instantaneous output enters the peak based on a determination that an instantaneous output change of the battery is greater than or equal to a threshold value during a preset unit time from a reference time point at which the instantaneous output of the battery exceeds a preset first reference output.

4. The apparatus of claim 3, wherein the processor is configured to control the power consumption of the target load by driving the target load to consume less power than power consumed by a user input.

5. The apparatus of claim 4, wherein the processor is configured to drive the target load to consume power greater than the power consumed by the user input after controlling the power consumption of the target load.

6. The apparatus of claim 1, wherein the processor is configured to determine that the instantaneous output enters the peak based on a determination that the instantaneous output change of the battery is greater than or equal to a threshold value during a preset unit time from a reference time point at which the instantaneous output of the battery is less than a preset second reference output.

7. The apparatus of claim 6, wherein the processor is configured to control the power consumption of the target load by driving the target load to consume greater power than power consumed by a user input.

8. The apparatus of claim 7, wherein the processor is configured to drive the target load to consume power less than the power consumed by the user input after controlling the power consumption of the target load.

9. The apparatus of claim 1, wherein the processor is configured to:
accumulate timing at which a peak control period for controlling power consumption of the target load proceeds, and
drive the target load based on a user input based on a determination that the accumulated peak control period is greater than or equal to a preset threshold period.

10. The apparatus of claim 1, wherein the processor is configured to:
determine an air conditioning system of the vehicle as the target load; and
drive the target load based on a user input based on a determination that a change in an indoor temperature of the vehicle according to control of power consumption of the air conditioning system is equal to or greater than a preset threshold temperature.

11. A vehicle comprising the apparatus of claim 1.

12. A method of controlling a battery system of a vehicle, the method comprising:
mounting a high voltage battery on the vehicle;
electrically connecting loads to the high voltage battery;
monitoring, by a processor, an instantaneous output of the high voltage battery and detecting a peak in which the instantaneous output of the high voltage battery exceeds a preset reference range;
determining, by the processor, a target load among loads electrically connected to the high voltage battery based on a detection of the peak; and
entering, by the processor, a peak reduction control period for reducing the peak and controlling power consumption of the target load.

13. The method of claim 12, wherein the determining of the peak includes:
detecting a reference time point at which the instantaneous output of the high voltage battery exceeds a preset first reference output; and
determining that the instantaneous output enters the peak based on a determination that an instantaneous output change of the high voltage battery is greater than or equal to a threshold value during a preset unit time from the reference time point.

14. The method of claim 13, wherein the controlling of the power consumption of the target load includes:
driving the target load to consume less power than power consumed by a user input.

15. The method of claim 14, further comprising:
compensating for a change in an output of the target load by driving the target load to consume power greater than the power consumed by the user input after controlling the power consumption of the target load.

16. The method of claim 12, wherein the determining of the peak includes:
detecting a reference time point at which the instantaneous output of the high voltage battery is less than a preset second reference output; and
determining that the instantaneous output enters the peak based on a determination that an instantaneous output change of the high voltage battery is greater than or equal to a threshold value during a preset unit time from the reference time point.

17. The method of claim 16, wherein the controlling of the power consumption of the target load includes:
driving the target load to consume greater power than power consumed by a user input.

18. The method of claim 17, further comprising:
compensating for a change in an output of the target load by driving the target load to consume power less than the power consumed by the user input after controlling the power consumption of the target load.

19. The method of claim 12, wherein the determining of the target load includes:
determining a load having highest power consumption during a preset unit time from a reference time point among the high voltage loads as the target load, and/or
wherein the controlling of the power consumption of the target load includes:
accumulating timing at which the peak reduction control period for controlling power consumption of the target load proceeds; and
driving the target load based on a user input based on a determination that the accumulated peak reduction control period is greater than or equal to a preset threshold period.

20. The method of claim 12, wherein the controlling of the power consumption of the target load includes:
controlling power consumption of an air conditioning system of a vehicle to allow the air conditioning system of the vehicle to be driven with power consumption greater than or less than power consumption by a user input;
detecting a change in indoor temperature of the vehicle according to the controlling of the power consumption of the air conditioning system; and
driving the target load based on the user input based on a determination that the change in indoor temperature is equal to or greater than a preset threshold temperature.
